(19) United States
(12) Patent Application Publication
(10) Pub. No.: US 2006/0267675 A1
(43) Pub. Date: Nov. 30, 2006

(54) PMOS current mirror with cascaded PMOS transistors and zero voltage gate threshold transistor

(75) Inventor: Vincent Thiery, La Roque D'Antheron (FR)

Correspondence Address: OSTROLENK FABER GERB & SOFFEN, 1180 AVENUE OF THE AMERICAS, NEW YORK, NY, 100368403, US

(73) Assignee: International Rectifier Corporation

(21) Appl. No.: 11/435,114

(22) Filed: May 16, 2006

Related U.S. Application Data
(60) Provisional application No. 60/684,417, filed on May 24, 2005.

(51) Int. Cl. G05F 1/10

(52) U.S. Cl. 327/543

(57) ABSTRACT

A current mirror circuit is provided that includes first and second transistors operating to control an output current that is directly related to a reference current. The circuit also includes a third transistor in cascade with the second transistor, wherein gates of all the transistors are connected together and the second transistor has a drain source voltage that is approximately equal to a drain source voltage of the first transistor, and wherein the third transistor has an approximately zero threshold voltage.

### CROSS-REFERENCE TO RELATED APPLICATION

This application is based on and claims the benefit of U.S. Provisional Application Ser. No. 60/684,417, filed on May 24, 2005, entitled PMOS CURRENT MIRROR WITH CASCADED PMOS TRANSISTORS AND ZERO VOLTAGE GATE THRESHOLD TRANSISTOR, to which a claim of priority is hereby made and the disclosure of which is incorporated by reference.

### BACKGROUND OF THE INVENTION

The present invention relates to a P-type metal oxide semiconductor (PMOS) current mirror circuits, and more particularly to a current mirror circuit having a very compact layout.

The PMOS is obtained by doping a semiconductor to increase the number of free positive charge carriers. FIG. 1a illustrates an exemplary prior art PMOS current mirror circuit 10 including PMOS transistors M1 and M2 operating in a saturation region of the circuit to control an output current I_{OUT}, which is directly related to the input or a reference current I_{REF}.

An improvement on a PMOS current mirror circuit 10, may be achieved when the second PMOS transistor M2 is cascaded by a third PMOS transistor M3. A cascade current mirror circuit is a popular form of a current source/sink circuits whose main feature lies in that the current through the transistor, i.e., current I_{OUT} through the transistor M2, is independent of the voltage V across the transistor M2. So, because of the cascade created by the third PMOS transistor M3, the second PMOS transistor M2 operates using a voltage V_{DS} that is similar to that of the first PMOS transistor M1. Therefore, current mirror matching is improved and does not depend on the output voltage.

FIG. 1a illustrates a prior art PMOS current mirror circuit 10. The circuit 10 uses very large and very long transistors M1 and M2 to eliminate the effect of the voltage V_{DS} on the output current I_{OUT}. Such circuit works well but requires a large silicon area for its implementation. The large area required for implementation of the circuit 10 is not appropriate for size sensitive applications.

FIG. 1b illustrates another prior art PMOS current mirror circuit 20. The circuit 20 generates a voltage that is equal to V_{M1} and the voltage V_{GM3} applied to a gate of the PMOS transistor M3 so that a drain of PMOS transistor M2 is at a voltage similar to that of PMOS transistor M1. One possibility to achieve such result is to use a PMOS transistor M3 in series with PMOS transistor M1 to create this voltage. In FIG. 1b, the transistors M3 and M3b have a threshold voltage of about 1V.

In some circuits, cascading PMOS transistor on the I_{REF} side of the circuit may cause a problem, because the minimum operating voltage then becomes twice the threshold voltage of the PMOS devices. This problem is addressed by a PMOS current mirror circuit 30 illustrated in FIG. 2. The circuit 30 uses long transistors for PMOS transistors M1 and M2 and a very wide transistor for PMOS transistor M3. In the circuit 30, all transistor gates are connected together to decrease a voltage V_{GS} between a gate and a source of the PMOS transistor M3 so that V_{DS} of PMOS transistors M2 and M3 are closer.

However, the circuit 30 only works for a limited range of current and the current mirror matching is not very good since V_{DS} of transistor M2 is lower than V_{DS} of transistor M1. For example, as shown, V_{DS}M₁=1.5V, V_{DS}M₂=1V and V_{T}M₃=0.5V.

### SUMMARY OF THE INVENTION

It is an object of the present invention to provide a superior PMOS current mirror circuit having a small size.

A current mirror circuit is provided that includes first and second transistors operating to control an output current that is directly related to a reference current. The circuit also includes a third transistor in cascade with the second transistor, wherein gates of all the transistors are connected together and the second transistor has a drain source voltage that is approximately equal to a drain source voltage of the first transistor, and wherein the third transistor has an approximately zero threshold voltage.

Other features and advantages of the present invention will become apparent from the following description of the invention that refers to the accompanying drawings.

### BRIEF DESCRIPTION OF THE DRAWINGS

FIGS. 1a and 1b are diagrams of prior art PMOS current mirror circuits including PMOS transistors operating to control an output current related to a reference current I_{REF};

FIG. 2 is a diagram of another prior art PMOS current mirror circuit operating to control an output current related to a reference current;

FIGS. 3a and 3b are diagrams of a PMOS current mirror circuit in accordance with a preferred embodiment of the invention;

FIG. 4 is a diagrams of a device replacing PMOS transistors in a PMOS current mirror circuit in accordance with a preferred embodiment of the invention; and

FIGS. 5a and 5b are graphs showing a dependence of a current I_{OUT} on the voltage V_{DS}.

### DETAILED DESCRIPTION OF EMBODIMENTS OF THE INVENTION

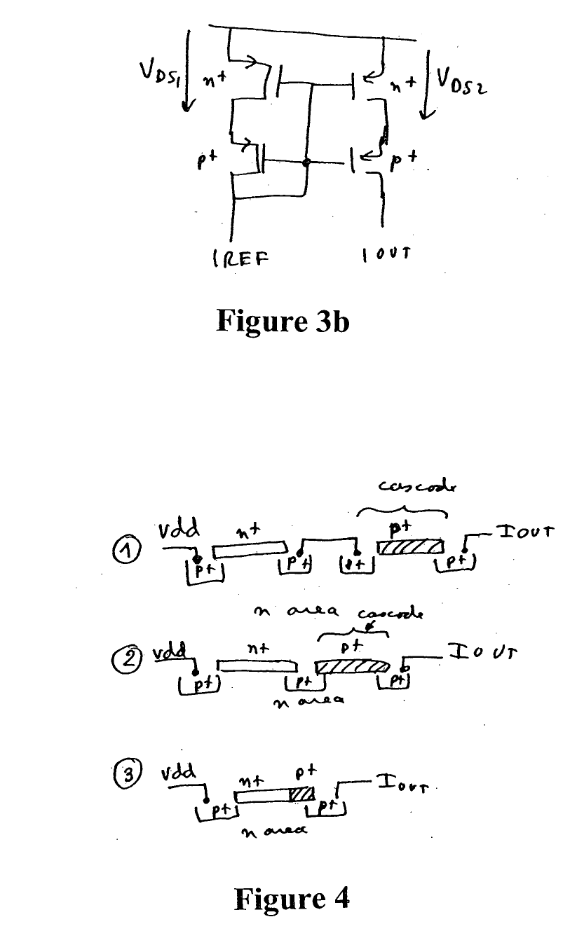

FIG. 3a illustrates a P-type metal oxide semiconductor (PMOS) current mirror circuit 40. The circuit 40 has all transistor gates connected together, like the circuit 30 of FIG. 2. However, instead of using long and wide transistors, the circuit 40 uses a PMOS transistor M3 with a very low V_{T}, ideally a V_{T} equal to 0, so that a V_{DS} of a PMOS transistor M1 is equal to a V_{GS} of the PMOS transistor M1 and is also equal to a V_{DS} of a PMOS transistor M2 minus a V_{T} of a PMOS transistor M3, and thus the V_{T} of a PMOS transistor M3 is equal to zero. This allows for a very compact layout.

Various voltages V_{T} for N-type metal oxide semiconductor (NMOS) and PMOS are available depending on the type of a gate doping. In particular, transistors whose V_{T} is equal to −1V for “P+” and “N+” doped gates, i.e., a standard transistor are available. PMOS transistors having V_{T} equal to 0V for “P+” doped gate only, e.g., a zero voltage device are also available, which are ideally suited for the cascaded transistor M3 of the circuit 40. In these devices the typical PMOS threshold with “N+” doped gate is around −1V. When doping “P+”, the threshold is increased by around 1 bandgap=1V. Thus the device threshold becomes close to 0V.

FIG. 3b illustrates a P-type PMOS current mirror circuit 50. In the circuit 50, whatever exact PMOS P+gate threshold V_{DS1}=V_{DS2} process variation will make PMOS P+gate =+/−0.2V.

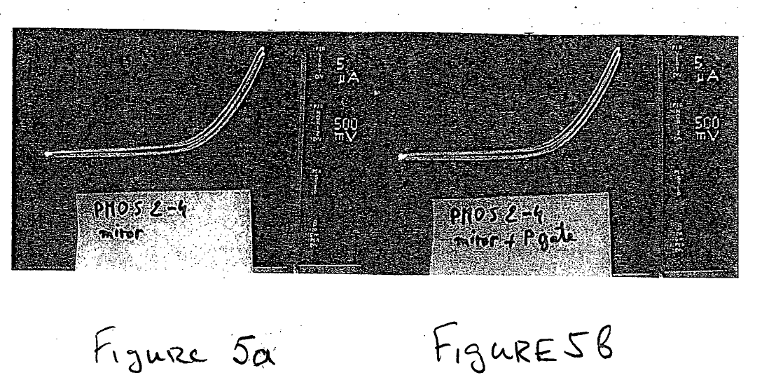

Furthermore, in another embodiment, the circuit 40 may include a special PMOS transistor composed of two gates, one type “N+P+” connected in series with a “P+” gate. Both gates are shorted together. This device replaces the PMOS transistors M2 and M3 of FIG. 3a in a compact layout. This is shown in FIG. 4, where three examples are illustrated indicating the source side and the cascode side.
1) Two transistors—one PMOS “normal” with N+gate, followed by a cascode PMOS with P+ gate;
2) Dual gate transistor—one PMOS with two in series gates, one gate being of type N+, followed by a coscode gate type P+ (similar to the first example combined with a type P+ implant); and
3) Dual doped single gate transistor one PMOS majority type N+ with 1 um of type P+ on the drain side, i.e., a self-cascode transistor.

In a variation, the gate is doped to type “P+” only on the drain side. Such doping is acceptable for a large L but may cause problem for a small L because an “N+” diffusion is large, typically 1.5 um, which is not negligible on a compact, 4 um long device.

In accordance with the preferred embodiment, the mirror current I_{OUT} does not depend upon the V_{DS} applied on the second leg of the mirror circuit. Additionally, the present invention is very useful when the gate length of the transistors is decreased to the 2 um range because the effect of the voltage V_{DS} on the current I_{OUT} becomes increasingly larger, i.e., early voltage.

A configuration of circuit 40 changes with regard to NMOS. The difference is that a P-gate will be used for transistors M1 and M2 and an N-gate for transistor M3. The P-gate voltage V_{T} may be equal 1.7V and the N-gate voltage V_{T} may be 0.8V. Voltages of 1V and 0V respectively would be preferable. The cascode also applies to NMOS where a process is designed to have a 0V threshold for NMOS N+gate and 1V for NMOS P+gate.

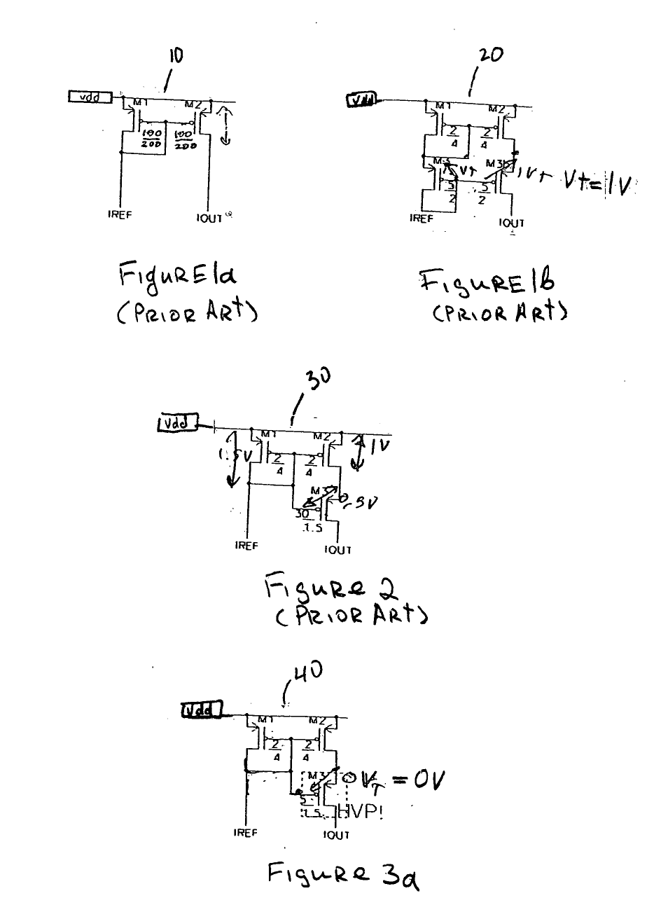

FIG. 5a shows a slight dependence of the current I_{OUT} at 2.5V on the voltage V_{DS} in the prior art current mirror circuit of FIG. 1a. FIG. 5b shows the graph for the circuit of the invention of FIG. 3a. There is no measurable variation when the P-gate is added to the mirror circuit. The variation may be small and not clearly visible, however, the amplifier gain is inversely proportional to the variation of the current with the voltage.

Although the present invention has been described in relation to particular embodiments thereof, many other variations and modifications and other uses will become apparent to those skilled in the art. It is preferred, therefore, that the present invention not be limited by the specific disclosure herein.

What is claimed is:

1. A current mirror circuit including first and second transistors operating to control an output current, the output current being directly related to a reference current, the circuit comprising a third transistor in cascade with the second transistor, wherein gates of all the transistors are connected together and the second transistor has a drain source voltage that is approximately equal to a drain source voltage of the first transistor, and wherein the third transistor has an approximately zero threshold voltage.

2. The circuit of claim 1, wherein all transistors are PMOS transistors.

3. The circuit of claim 2, wherein the connection of all transistor gates together decreases a voltage V_{GS} between the gate and the source of the third transistor so that voltages V_{DS} of the second and third transistors are similar and the voltage V_{DS} of the second transistor is lower than the voltage V_{DS} of the first transistor.

4. The circuit of claim 2, wherein a voltage V_{DS} of the first transistor is equal to a voltage V_{GS} of the first transistor and is equal to a voltage V_{DS} of the second transistor minus a voltage V_{T} of the third transistor, the voltage V_{T} being equal to zero.

5. The circuit of claim 1, wherein the effect of the first voltage on the output current is eliminated.

6. The circuit of claim 1, wherein the second and third transistors comprise a PMOS transistor comprising a “N+P+” gate connected in series with a gate of a “P+” device.

7. The circuit of claim 6, wherein the gate is doped to type “P+” only on the drain side.
